(19) United States
(12) Patent Application Publication
(10) Pub. No.: US 2015/0307736 A1
(43) Pub. Date: Oct. 29, 2015

(54) Corrosion-Resistant TGIC Primer Coating

(71) Applicant: Valspar Sourcing, Inc., Minneapolis, MN (US)

(72) Inventors: Thomas E. Reno, Americus, GA (US); Wenjing Zhou, Cypress, TX (US)

(73) Assignee: VALSPAR SOURCING, INC., Minneapolis, MN (US)

(21) Appl. No.: 14/789,439

(22) Filed: Jul. 1, 2015

Related U.S. Application Data
(63) Continuation of application No. PCT/US2013/077361, filed on Dec. 22, 2013.
(60) Provisional application No. 61/749,056, filed on Jan. 4, 2013.

(51) Int. Cl. C09D 167/00; B05D 3/00

(52) U.S. Cl. CPC C09D 167/00; B05D 3/007

(57) ABSTRACT

Methods, formulations, and systems for coating metal substrates are provided. The methods and systems include application of TGIC-based powder coatings that demonstrate excellent corrosion resistance when exposed to outdoor conditions, as demonstrated by cyclic corrosion testing.

### CROSS-REFERENCE TO RELATED APPLICATION(S)

This application is a continuation of International Application No. PCT/US2013/077361 filed Dec. 22, 2013, which claims the benefit of U.S. Provisional Application Ser. No. 61/749,056 filed Jan. 4, 2013, each of which is incorporated herein by reference in its entirety.

### FIELD OF INVENTION

Powder coatings are solvent-free, 100% solids coating systems that have been used as low VOC and low cost alternatives to traditional liquid coatings and paints.

Powder coatings may be used for architectural applications, especially where increased weathering and resistance to atmospheric exposure are needed. Such coatings are usually formed from polyester resins and typically demonstrate superior gloss retention and good chemical resistance. However, these coatings do not demonstrate sufficient corrosion resistance when subjected to standard tests, such as cyclic corrosion testing (CCT), for example. Conventionally, therefore, these coatings have not found use as single component coatings for exterior weathering applications and are typically topcoated to 100% coverage to ensure the primer does not degrade on prolonged exposure to sunlight.

From the foregoing, it will be appreciated that there is a need for exterior polyester resin-based primer coatings that provide excellent weathering characteristics and optimal corrosion resistance.

### SUMMARY

The invention described herein includes systems for improving the corrosion resistance of an exterior weatherable powder coating. The system includes a formulation containing a TGIC-reactive binder resin and about 1 to 10% by weight of at least one saturated high molecular weight linear polyester. A cured coating made from the system provides improved corrosion resistance on cyclic corrosion testing (CCT) relative to a standard or conventional powder formulation used in exterior weathering applications.

In another embodiment, the present invention includes methods and systems for coating a metal substrate. The method includes providing a substrate and at least one powder formulation, where the powder formulation includes a TGIC-reactive polymeric binder, and a saturated, high molecular weight polyester resin composition. The formulation is applied and cured to form a coating that demonstrates at least about 40% improved corrosion resistance on CCT.

The details of one or more embodiments and aspects of the invention are set forth below. Other features, objects, and advantages of the invention will be apparent from the description and from the claims.

### SELECTED DEFINITIONS

Unless otherwise specified, the following terms as used herein have the meanings provided below.

The term “on”, when used in the context of a coating applied on a surface or substrate, includes both coatings applied directly or indirectly to the surface or substrate.

Thus, for example, a coating applied to a primer layer overlying a substrate constitutes a coating applied on the substrate. Additionally, the term “substrate,” as used herein refers to surfaces that are untreated, unprimed or clean-blasted, and also to surfaces that have been primed or pretreated by various methods known to those of skill in the art, such as electrocoating treatments, for example.

Unless otherwise indicated, the term “polymer” includes both homopolymers and copolymers (i.e., polymers of two or more different monomers). As used herein, the term “(meth)acrylate” includes both acrylic and methacrylic monomers and homopolymers as well as copolymers containing the same.

As used herein, the term “corrosion resistance” refers to the ability of a coating to prevent corrosion of a metal test panel during a standard corrosion test. The cyclic corrosion test (CCT) refers to a standard test for produce coating failure that is representative of the failure that occurs in a corrosive outdoor environment. Test panels are exposed to a series of different environments, such as, for example, a wet environment or a dry environment in a repetitive cycle for a given period of time.

Coatings that pass CCT are considered corrosion resistant.

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a”, “an”, “the”, “at least one”, and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

Embodiments of the invention described herein include formulations, methods and systems for powder-coating a metal substrate. The methods include steps for applying at least a first powder formulation to a substrate, wherein the formulation includes a TGIC-reactive binder, and a linear polyester resin. The methods further include curing the composition to obtain a cured coating that demonstrates excellent corrosion resistance on cyclic corrosion testing.

Accordingly, in some embodiments, the present invention provides formulations, methods or systems for coating a substrate. In an aspect, the formulation, method and systems described herein include applying a powder composition to a substrate to be used in an exterior or outdoor environment. In another aspect, the method and systems described herein include applying a powder composition to a metal substrate to be used in a corrosive environment. In yet another aspect, the methods and system described herein include applying a powder composition to an unprimed substrate, i.e., as a primer coating on cold-rolled steel, for example, such that complete coverage with a topcoat is not necessary for corrosion protection or weathering.

In an embodiment, the methods described herein include applying at least a first powder composition to a substrate. The powder composition is a fusible composition that melts on application of heat to form a coating film. The powder is applied using methods known to those of skill in the art, such as, for example, electrostatic spray methods, to a film thickness of about 10 to about 50 microns, preferably 20 to 40 microns. In an aspect, a first powder composition is applied to either a clean (i.e., unprimed) or pretreated surface of a metal substrate, i.e. the first powder composition may be applied to a metal surface that is unprimed, that has been clean-blasted, or a surface that has been pretreated by various methods known to those of skill in the art, such as electrocoat, for example. In another aspect, the powder composition is applied to a substrate used in an outdoor or exterior environment.

In an embodiment, the first powder composition includes at least one polymeric binder. The powder composition may also optionally include one or more pigments, opacifying agents or other additives.

Suitable polymeric binders generally include a film forming resin and optionally a curing agent for the resin. The binder may be selected from any resin or combination of resins that provides the desired film properties. Suitable examples of polymeric binders include amorphous and crystalline thermoset and/or thermoplastic materials, and can be made with epoxy, polyester, polyurethane, polyamide, acrylic, polyvinylchloride, nylon, fluoropolymer, silicone, other resins, or combinations thereof. Thermoset materials are preferred for use as polymeric binders in powder coating applications, and epoxies, polyesters and acrylics are particularly preferred. If desired, elastomeric resins may be used for certain applications. In an aspect, specific polymeric binders or resins are included in the powder compositions described herein depending on the desired end use of the powder-coated substrate. For example, certain high molecular weight polyesters show superior corrosion resistance and are suitable for use on substrates used for interior and exterior applications. Similarly, amorphous polyesters are useful in applications where clarity, color, and chemical resistance are desired.

Examples of preferred binders include the following: carboxyl-functional polyester resins cured with epoxide-functional compounds (e.g., triglycidyl-isocyanurate or TGIC), carboxyl-functional polyester resins cured with polymeric epoxy resins, carboxyl-functional polyester resins cured with hydroxyalkyl amides, hydroxyl-functional polyester resins cured with blocked isocyanates or uretdiones, epoxy resins cured with amines (e.g., dicyandiamide), epoxy resins cured with phenolic-functional resins, epoxy resins cured with carboxyl-functional curatives, carboxyl-functional acrylic resins cured with polymeric epoxy resins, hydroxyl-functional acrylic resins cured with blocked isocyanates or uretdiones, unsaturated resins cured through free radical reactions, and silicone resins used either as the sole binder or in combination with organic resins. The optional curing reaction may be induced thermally, or by exposure to radiation (e.g., UV, UV-vis, visible light, IR, near-IR, and e-beam).

In a preferred embodiment, the polymeric binder described herein is a superdurable carboxy-functional polyester resin, such as a TGIC-reactive polyester resin, for example. TGIC, a triazine compound with reactive epoxy functional groups, is known in the art as a curing agent for acid-functional resins, such as acrylic resins, polyester resins, and the like, for example. In an aspect, the TGIC-reactive polyester described herein includes up to about 10 wt %, more preferably about 5 to 9 wt %, and most preferably about 7 to 8 wt % TGIC, based on the total weight of the binder resin. In a preferred aspect, the TGIC-reactive polyester is 93:7 TGIC. These TGIC-reactive resins are known to have high hardness, good chemical resistance and good weathering, but suffer from poor flexibility and impact resistance.

In an embodiment, the powder formulation includes a non-reactive linear polyester resin. In a preferred aspect, the coil resins used in the powder compositions described herein include linear polyesters, acrylate-modified polyesters, or alkyd-modified polyesters. In an aspect, the linear polyester resin is a high molecular weight resin, with a number average molecular weight (Mn) of preferably 10,000 to 25,000, more preferably 15,000 to 20,000. In an aspect, the linear polyester resin is present in an amount of preferably 1 to 10 wt %, more preferably 3 to 8 wt %, and most preferably 4 to 7 wt %, based on the total weight of the formulation. Non-reactive linear polyesters are typically used as additives in powder coating compositions to obtain coatings with improved flexibility. Surprisingly, when used in the formulations and methods described herein, the non-reactive linear polyester provides improved corrosion resistance, especially as demonstrated by CCT.

Without limiting to theory, it is believed that the corrosion resistance of coatings, such as exterior weatherable coatings made from TGIC-reactive polyesters, for example, may be improved over conventional epoxy-based coating formulations. Typically, epoxy-based compositions are applied as primer coating on exterior weatherable parts and must be topcoated, at 100% coverage, to ensure that the underlying epoxy-based primer is not degraded by uv exposure from sunlight, and subsequent corrosion. The formulations and methods described herein surprisingly provide excellent corrosion protection, even on exposure to uv radiation. Moreover, when used as a primer, the coating made from the formulation described herein does not require 100% coverage by a topcoat, and in fact, provides surprising corrosion protection even in the absence of a topcoat.

In an embodiment, the powder formulation described herein includes at least one wetting or dispersing additive. In an aspect, the additive is high molecular weight, with a number average molecular weight (Mn) of preferably about 10,000 to 25,000, more preferably 15,000 to 20,000. In another aspect, the additive is a salt of an unsaturated polymeric compound, including, for example, unsaturated polymeric materials having a multiplicity of amino- and/or amido- groups in the polymer chain, and a polyester. In a preferred aspect, the additive is a salt of an unsaturated polyamine amide and a low molecular weight (Mn≦10,000) polyester. Commercially available examples of the additive described herein include the Anti-Terra U line of wetting agents, for example.

The additive is preferably solvent-free, and present in an amount of preferably about 0.1 to 1.0 wt %, more preferably 0.2 to 0.5 wt %, and most preferably 0.3 to 0.6 wt %, based on the total weight of the formulation.

In an embodiment, the powder composition described herein includes other additives, such as adhesion promoters, for example. Without limiting to theory, it is believed that the corrosion resistance of a coating is improved when desorption of the coating on exposure to water or moisture is prevented, and adhesion promoters help reduce desportion. Adhesion promotes may also promote compatibility between otherwise incompatible polymers in a formulation. Accordingly, adhesion promoters for use in the formulations, methods and systems described herein include, without limitation, monofunctional, difunctional and polyfunctional compounds, such as, for example, amines, carboxy-functional compounds such as, for example, acids, acid anhydrides, and the like, hydroxy-functional compounds such as, for example, phenols, alcohols, and the like, thiols, metal organic compounds, and derivatives and combinations thereof. In a preferred aspect, the adhesion promoter is a hybrid carboxy-functional hydroxy-functional metal organic compound, including, for example, the Chartsil line of adhesion promoters (Chartwell International, Massachusetts). In a preferred aspect, the powder formulation described herein includes up to about 3 wt % adhesion promoter, preferably about 0.1 to 2 wt %, more preferably about 0.5 to 1 wt %, based on the total weight of the powder formulation.

The powder composition may include other additives. These other additives can improve the application of the powder coating, the melting and/or curing of that coating, or the performance or appearance of the final coating. Examples of optional additives which may be useful in the powder include: cure catalysts, antioxidants, color stabilizers, slip and mar additives, UV absorbers, hindered amine light stabilizers, photoinitiators, conductivity additives, tribocharging additives, anti-corrosion additives, fillers, texture agents, degassing additives, flow control agents, thixotropes, and edge coverage additives.

The powder coating composition described herein is made by conventional methods known in the art. The polymeric binder is dry mixed together with the additives, and then is typically melt blended by passing through an extruder. The resulting extrudate is solidified by cooling, and then ground or pulverized to form a powder. Other methods may also be used. For example, one alternative method uses a binder that is soluble in liquid carbon dioxide. In that method, the dry ingredients are mixed into the liquid carbon dioxide and then sprayed to form the powder particles. If desired, powders may be classified or sieved to achieve a desired particle size and/or distribution of particle sizes.

The resulting powder is at a size that can effectively be used by the application process. Practically, particles less than 10 microns in size are difficult to apply effectively using conventional electrostatic spraying methods. Consequently, powders having median particle size less than about 25 microns are difficult to electrostatically spray because those powders typically have a large fraction of small particles. Preferably the grinding is adjusted (or sieving or classifying is performed) to achieve a powder median particle size of about 25 to 150 microns, more preferably 30 to 70 microns, most preferably 30 to 50 microns.

Optionally, other additives may be used in the present invention. As discussed above, these optional additives may be added prior to extrusion and be part of the base powder, or may be added after extrusion. Suitable additives for addition after extrusion include materials that would not perform well if they were added prior to extrusion; materials that would cause additional wear on the extrusion equipment, or other additives.

Additionally, optional additives include materials which are feasible to add during the extrusion process, but may also be added later. The additives may be added alone or in combination with other additives to provide a desired effect on the powder finish or the powder composition. These other additives can improve the application of the powder, the melting and/or curing, or the final performance or appearance. Examples of optional additives which may be useful include: cure catalysts, antioxidants, color stabilizers, slip and mar additives, photoinitiators, conductivity additives, tribocharging additives, anti-corrosion additives, fillers, texture agents, degassing additives, flow control agents, thixotropes, and edge coverage additives.

Other preferred additives include performance additives such as rubberizers, friction reducers, and microcapsules. Additionally, the additive could be an abrasive, a heat sensitive catalyst, an agent that helps create a porous final coating, or that improves wetting of the powder.

Techniques for preparing powder compositions are known to those of skill in the art. Mixing can be carried out by any available mechanical mixer or by manual mixing. Some examples of possible mixers include Henschel mixers (available, for example, from Henschel Mixing Technology, Green Bay, Wis.), Mixaco mixers (available from, for example, Triad Sales, Greer, S.C. or Dr. Herfeld GmbH, Neuenrade, Germany), Marion mixers (available from, for example, Marion Mixers, Inc., 3575 3rd Avenue, Marion, Iowa), invertible mixers, Littleford mixers (from Littleford Day, Inc.), horizontal shaft mixers and ball mills. Preferred mixers would include those that are most easily cleaned.

Powder coatings are generally manufactured in a multi-step process. Various ingredients, which may include resins, curing agents, pigments, additives, and fillers, are dry-blended to form a premix. This premix is then fed into an extruder, which uses a combination of heat, pressure, and shear to melt fusible ingredients and to thoroughly mix all the ingredients. The extrudate is cooled to a friable solid, and then ground into a powder. Depending on the desired coating end use, the grinding conditions are typically adjusted to achieve a powder median particle size of about 25 to 150 microns.

The final powder may then be applied to an article by various means including the use of fluid beds and spray applicators. Most commonly, an electrostatic spraying process is used, wherein the particles are electrostatically charged and sprayed onto an article that has been grounded so that the powder particles are attracted to and cling to the article. After coating, the article is heated. This heating step causes the powder particles to melt and flow together to coat the article. Optionally, continued or additional heating may be used to cure the coating. Other alternatives such as UV curing of the coating may be used.

The coating is optionally cured, and such curing may occur via continued heating, subsequent heating, or residual heat in the substrate. In another embodiment of the invention, if a radiation curable powder coating base is selected, the powder can be melted by a relatively short or low temperature heating cycle, and then may be exposed to radiation to initiate the curing process. One example of this embodiment is a UV-curable powder. Other examples of radiation curing include using UV-vis, visible light, near-IR, IR and e-beam.

The compositions and methods described herein may be used with a wide variety of substrates. Typically and preferably, the powder coating compositions described herein are used to coat metal substrates, including without limitation, unprimed metal, clean-blasted metal, and pretreated metal, including plated substrates, ecoat-treated metal substrates, and substrates that are the same color as the powder coating composition. Typical pretreatments for metal substrates include, for example, treatment with iron phosphate, zinc phosphate, and the like. Metal substrates can be cleaned and pretreated using a variety of standard processes known in the industry. Examples include, without limitation, iron phosphating, zinc phosphating, nanoceramic treatments, various ambient temperature pretreatments, zirconium containing pretreatments, acid pickling, or any other method known in the art to yield a clean, contaminant-free surface on a substrate.

The coating compositions and methods described herein are not limited to conversion coatings, i.e. parts or surfaces treated with conversion coatings. Moreover, the coating compositions described herein may be applied to substrates previously coated by various processes known to persons of skill in the art, including for example, ecoat methods, plating methods, and the like. There is no expectation that substrates to be coated with the compositions described herein will always be bare or unprimed metal substrates.

Preferably, the coated substrate has desirable physical and mechanical properties. Typically, the final film coating will have a thickness of 25 to 200 microns, preferably 50 to 150 microns, more preferably 75 to 125 microns.

Conventionally, epoxy-based powder coatings are used on exterior weatherable parts because of the improved corrosion resistance provided by the coating. However, such epoxy-based coatings experience significant degradation on exposure to UV radiation, i.e., exposure to sunlight. Therefore, the epoxy-based coatings are typically used as primers and covered with a weatherable or durable topcoat, which forms a barrier and improves the coating's resistance to UV degradation. However, in order to prevent corrosion and subsequent loss of adhesion, the topcoat must be applied at 100% coverage. Surprisingly, the formulations, methods and systems described herein combine TGIC-reactive resins with an additive package to produce a corrosion-resistant coating that does not require the application of a topcoat to resist UV degradation.

The corrosion resistance of the coatings produced by the methods and systems described herein is evaluated by cyclic corrosion testing. Cyclic corrosion testing is a standard method for accelerated corrosion testing. Test panels are typically exposed to repeated cycles of intermittent exposure to salt solution, elevated temperature and/or humidity and drying. This type of testing is preferred over conventional salt spray methods, which do not always reproduce degradation or corrosion observed under natural weathering conditions. The powder composition described herein produces coating that have optimal corrosion resistance even on prolonged exposure to outdoor conditions, as measured by creep from scribe. For example, when applied over a metal substrate, significantly less delamination of the powder coating is seen. The following examples are offered to aid in understanding of the present invention and are not to be construed as limiting the scope thereof Unless otherwise indicated, all parts and percentages are by weight.

### EXAMPLES

Powder coating compositions #1 to #4 were prepared by standard methods, using

TGIC and carboxy-functional polyester resin as the binder system, at 80% formulation weight. Composition #1 is prepared by combining TGIC with a carboxy-functional polyester resin at 80% formula weight. Similarly, composition #2 is prepared by combining TGIC with a saturated carboxy-functional polyester resin at 80% formula weight. The additive package described herein, including a linear polyester resin, a dispersing additive, and an adhesion promoter, was added to compositions #1 and #2 in the amounts shown in Table 1, based on the total weight of the formulation, to give compositions #3 and #4. The coating compositions #1 to #4 were applied to cold rolled steel (CRS) test panels and cured to form powder coatings. A 10 mm scribe to metal was made in each test panel, and the panels were subjected to cyclic corrosion testing under standard CCT conditions for 20 cycles. Test results are shown in Table 1, and demonstrate that the additive package as described herein provides improved corrosion resistance. It is noted that using the linear polyester alone as an additive also provides improved corrosion resistance (results not shown).

| | Sample #1 | Sample #2 | Sample #3 | Sample #4 |
|---|---|---|---|---|
| Linear polyester | — | — | 5% | 5% |
| Dispersing agent | — | — | 0.5% | 0.5% |
| Adhesion promoter | — | — | 1% | 1% |
| Average creep from | 2.82 | 3.08 | 1.62 | 1.52 |
| scribe (mm) | | | | |

What is claimed is:

1. A system for improving the corrosion resistance of an exterior weatherable powder coating, comprising a powder formulation, the formulation comprising
a TGIC-reactive polymeric binder; and
about 1 to 10 wt % of a saturated, high molecular weight (Mn) non-reactive polyester, based on the total weight of the formulation, wherein corrosion resistance of a cured coating formed from the formula is improved by 40% over a standard powder coating, when subjected to cyclic corrosion testing.

2. A formulation for improving the corrosion resistance of an exterior weatherable powder coating, comprising
a TGIC-reactive polymeric binder; and
about 1 to 10 wt % of a saturated, high molecular weight (Mn) non-reactive polyester, based on the total weight of the formulation, wherein corrosion resistance of a cured coating formed from the formula is improved by 40% over a standard powder coating, when subjected to cyclic corrosion testing.

3. A method for improving the corrosion resistance of an exterior weatherable powder coating, comprising
providing a substrate;
applying a powder coating formulation, the formulation comprising a TGIC-reactive polymeric binder; and
about 1 to 10 wt % of a saturated, high molecular weight (Mn) non-reactive polyester, based on the total weight of the formulation;
curing the applied powder coating formulation to form a cured coating; and
testing the cured coating by cyclic corrosion testing,
wherein corrosion resistance of the cured coating is improved by 40% over a standard powder coating, when subjected to cyclic corrosion testing.

4. The Method of claim 3, wherein the powder coating formulation further comprises
up to about 0.5 wt % of a salt of an unsaturated polyamine amide and a low molecular weight (Mn) polyester; and
up to about 2 wt% of a hybrid carboxy/hydroxy functional metal organic adhesion promoter.

5. The method of claim 3, wherein the powder coating formulation comprises about 0.1 to about 0.3 wt % of a salt of an unsaturated polyamine amide and a low molecular weight (Mn) polyester; and
about 0.5 to about 1 wt % of a hybrid carboxy/hydroxy functional metal organic adhesion promoter.

6. The method of claim 3, wherein the powder coating formulation comprises about 2 to about 5 wt % of the non-reactive polyester;
about 0.1 to about 0.3 wt % of a salt of an unsaturated polyamine amide and a low molecular weight (Mn) polyester; and
about 0.5 to about 1 wt % of a hybrid carboxy/hydroxy functional metal organic adhesion promoter.
